(19) United States
(12) Patent Application Publication
(10) Pub. No.: US 2020/0327743 A1
(43) Pub. Date: Oct. 15, 2020

(54) METHODS FOR AUTOMATICALLY PROCESSING VEHICLE COLLISION DAMAGE ESTIMATION AND REPAIR WITH WEARABLE COMPUTING DEVICES

(71) Applicant: Mitchell International, Inc., San Diego, CA (US)

(72) Inventor: Umberto Laurent Cannarsa, Carlsbad, CA (US)

(73) Assignee: Mitchell International, Inc., San Diego, CA (US)

(21) Appl. No.: 16/845,017

(22) Filed: Apr. 9, 2020

Related U.S. Application Data
(60) Provisional application No. 62/834,160, filed on Apr. 15, 2019.

(51) Int. Cl. G07C 5/00; G06Q 10/00; G06T 7/00; H04M 1/60; G06Q 40/08; G06N 20/00

(52) U.S. Cl. CPC G07C 5/008; G07C 5/006; G06Q 10/20; G06N 20/00; H04M 1/6041; G06Q 40/08; G06T 7/0004

(57) ABSTRACT

Systems and methods are provided for automatically generating a repair estimate report for repairing a damaged vehicle. A user may be directed to capture data that includes vehicle information (e.g., VIN) and damage information (e.g., images of damaged panels and parts) using a computer wearable device based on intake instructions generated by the system. The damage information may be analyzed to obtain repair information. The repair estimate may be submitted to an insurance carrier and a notification specifying an approval or rejection may be generated. The user may use the system in a handsfree manner by viewing and/or listening to intake instructions, vehicle information, and the status of the repair estimate approval in a display and/or through speakers, respectively, of a computer wearable device.

### RELATED APPLICATIONS

This application claims the benefit of U.S. Provisional Application No. 62/834,160 filed on Apr. 15, 2019, the contents of which are incorporated herein by reference in its entirety.

### TECHNICAL FIELD

The present disclosure is generally related to automobiles. More particularly, the present disclosure is directed to automotive collision repair technology.

### BACKGROUND

Conventional preparation of a repair estimate involves analyzing different aspects of the damage associated with the insured item (e.g., an automotive vehicle) in order to determine an estimate of the compensation for repairing the loss.

Existing technological tools used to assist the party performing the estimate are limited to software estimation tools. However, the use of these tools is predicated upon collecting a variety of data related to the vehicle and the damage, which traditionally comes in various formats and must be gathered from different sources, thus making conventional tools ineffective. For example, the data collection process may start with identification of the damaged vehicle by copying a 17-character Vehicle Identification Number and typing this number into the estimating software. Additionally, the estimator needs to identify and manually input all the damaged parts. Finally, as part of the estimating process, insurance companies require the estimator to attach between 20 and 50 images of the damaged areas to the estimate, and sometimes more. Accordingly, conventional repair estimate methods are time-consuming and susceptible to human error.

### SUMMARY

In accordance with one or more embodiments, various features and functionality can be provided to automatically generate a repair estimate based on vehicle information and damage information collected by a user.

In some embodiments, a method for automating the process of preparing a repair estimate may include obtaining a first set of images of a vehicle damaged during an adverse incident. The first set of damaged vehicle images may be captured by a computing device operated by a user. In some embodiments, the computing device includes a wearable computing device worn by the user.

In some embodiments, vehicle identification information associated with the damaged vehicle may be obtained by processing images of vehicle identification information. In some embodiments, the method may extract Vehicle Identification Number (VIN) from a captured image of the vehicle identification information. In some embodiments, the method may obtain vehicle information associated with the damaged vehicle based on the extracted VIN. The vehicle information may include a year of manufacture, a make, a model, a sub-model, a configuration, an engine type, and a transmission type of the damaged vehicle.

In some embodiments, the first set of instructions that guide the user during the image capture process of the first set of damaged vehicle images may be generated. For example, the first set of instructions may be generated based on the vehicle identification information.

In some embodiments, the first set of damaged vehicle images may be used to identify individual parts of the damaged vehicle. In some embodiments, individual parts of the damaged vehicle associated with the first set of damaged vehicle images may be identified using one or more image processing techniques.

In some embodiments, a second set of damaged vehicle images may be obtained based on the identified individual parts of the damaged vehicle, wherein the second set of damaged vehicle images is captured by the computing device operated by the user.

In some embodiments, a second set of instructions that guide the user during the image capture process of the second set of damaged vehicle images may be generated. For example, the second set of instructions may be generated based on the damage information associated with each of the identified individual parts of the damage vehicle.

In some embodiments, damage information associated with each of the identified individual parts of the damage vehicle may be determined. For example, determining the damage information associated with each of the identified individual parts of the damage vehicle may include using a machine learning algorithm trained on the historic repair estimate information.

In some embodiments, repair information for repairing individual damaged parts of the damaged vehicle based on the determined damage information may be obtained.

In some embodiments, a repair estimate report based on the repair information associated with repairing individual damaged parts may be generated.

In some embodiments, an insurance carrier associated with the adverse incident based on the vehicle identification information may be identified.

In some embodiments, the repair estimate report may be transmitted to the insurance carrier. In some embodiments, upon obtaining an approval of the transmitted repair estimate report from the insurance carrier, a notification may be generated.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 illustrates example systems and a network environment, according to an implementation of the disclosure.

FIG. 2 illustrates an example damage and repair estimate server of the example environment of FIG. 1, according to an implementation of the disclosure.

FIGS. 3A-3B illustrate an example client computing device of the example environment of FIG. 1, according to an implementation of the disclosure.

FIGS. 4A-4C illustrate an example graphical user interface displaying directional instructions during an image capture of vehicle information, according to an implementation of the disclosure.

FIGS. 5A-5E illustrate an example graphical user interface displaying directional instructions during an image capture of damage information, according to an implementation of the disclosure.

FIG. 5F illustrates an example graphical user interface displaying a notification approving a repair estimate, according to an implementation of the disclosure.

FIG. 6 illustrates an example process for generating a repair estimate, according to an implementation of the disclosure.

FIG. 7 illustrates an example computing system that may be used in implementing various features of embodiments of the disclosed technology.

### DETAILED DESCRIPTION

Described herein are systems and methods for automating the preparation of a repair estimate for a damaged vehicle. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As stated above, conventional preparation of a repair estimate relies on manually entered information related to the vehicle and the damage. For example, a repair estimator may manually enter VIN and provide basic identifying and/or validating vehicle information, including the make, model, and year of manufacture. Next, the estimator may identify the damaged panels and parts, determine the severity of the damage, and obtain repair information to repair and/or replace each of the damaged parts. Further, the estimator may upload images of the identified damaged panels and/or parts. Finally, the estimator may transmit a conventionally generated repair estimate report to an insurance carrier for approval. The insurance carrier may not always approve the repair estimate right away; instead the carrier may request additional information, e.g., more images of damaged panels. The repairs may only be started after receiving the approval of the repair estimate from the insurance carrier. Accordingly, the repair estimate preparation process relies on manual data entry and requires the user to utilize multiple devices (e.g., a computer and a digital camera). Because manual data entry is time-consuming and is prone to errors, it often causes delays in repair estimate approval. For example, currently available technology lacks analytics with respect to capturing damage data and cannot determine whether the captured images are sufficient.

In accordance with various embodiments, an estimator can obtain intake instructions for capturing vehicle and damage information by viewing them on a display of a computer wearable device. For example, the estimator can view intake instructions for capturing vehicle information used to identify the type of vehicle without entering the information, but rather by using an input device (e.g., a camera) on the computer wearable device, resulting in a handsfree data entry. By allowing the user to perform the information intake process in a guided, handsfree manner results in a significant reduction in time it usually takes to process a repair estimate. Vehicle information is used to determine relevant intake instructions for capturing damage information. The damage images are analyzed and a determination is made whether additional images are necessary. By automatically determining what additional damage data is required, the accuracy of captured information results in improved repair estimate processing time. Upon capturing all relevant damage images, a repair estimate report is generated and transmitted to an insurance carrier for approval.

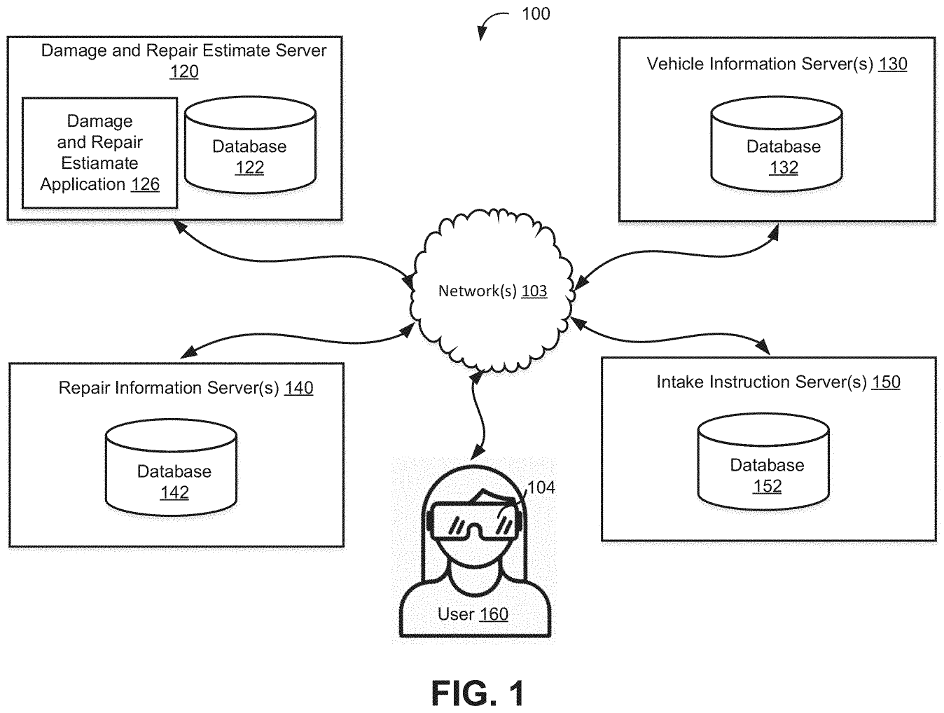

Before describing the technology in detail, it is useful to describe an example environment in which the presently disclosed technology can be implemented. FIG. 1 illustrates one such example environment 100.

FIG. 1 illustrates an example environment 100 which automates the processing and preparation of a repair estimate for a damaged vehicle. For example, a user conducting the intake process may collect information related to the damaged vehicle, its owner, and the damage sustained by the vehicle. The user may input the information by capturing images or by using voice commands without having to enter input via a graphical user interface (GUI) of a conventional damage estimation software, resulting in a handsfree intake process, as described herein. Furthermore, during the information intake process (e.g., intake of collision damage images), the user is guided by a set of intake instructions which are displayed in and/or transmitted via a speaker of a client computing device 104, further facilitating handsfree information intake. The damage information is then processed (e.g., by using machine learning algorithms) to determine the extent of the damage, and a repair estimate report is generated.

In some embodiments, the set of instructions guiding the user through the damage information intake process may be generated based on the specific requirements of an insurance carrier (e.g., number of images to be collected), the geographic location associated with the occurrence of the incident and the issuance of the insurance policy, and/or the of the damage itself, as further described herein.

In some embodiments, environment 100 may include a client computing device 104, a damage and repair estimate server 120, a one or more vehicle information server(s) 130, a one or more repair information server(s) 140, a one or more intake instruction server(s) 150, and a network 103. A user 160 may be associated with client computing device 104 as described in detail below. Additionally, environment 100 may include other network devices such as one or more routers and/or switches.

In some embodiments, client computing device 104 may include a variety of electronic computing devices, for example, a wearable computing device, such as smart glasses, or any other head mounted display device that can be used by a user (e.g., an estimator). In some embodiments, the wearable computing device may include a transparent heads-up display (HUD) or an optical head-mounted display (OHMD). In other embodiments, client computing device 104 may include other types of electronic computing devices, such as, for example, a smartphone, tablet, laptop, virtual reality device, augmented reality device, display, mobile phone, or a combination of any two or more of these data processing devices, and/or other devices.

In some embodiments, client computing device 104 may include one or more components coupled together by a bus or other communication link, although other numbers and/or types of network devices could be used. For example, client computing device 104 may include a processor, a memory, a display (e.g., OHMD), an input device (e.g., a voice/gesture activated control input device), an output device (e.g., a speaker), an image capture device configured to capture still images and videos, and a communication interface.

In some embodiments, client computing device 104 may present content (e.g., intake instructions) to a user and receive user input (e.g., voice commands). For example, client computing device 104 may include a display device, as alluded to above, incorporated in a lens or lenses, and an input device(s), such as interactive buttons and/or a voice or gesture activated control system to detect and process voice/gesture commands. The display of wearable computing device 104 may be configured to display the instructions aimed at facilitating a handsfree and voice- and/or gesture-assisted intake of information. In some embodiments, client computing device 104 may communicate with information intake server 120 via network 103 and may be connected wirelessly or through a wired connection.

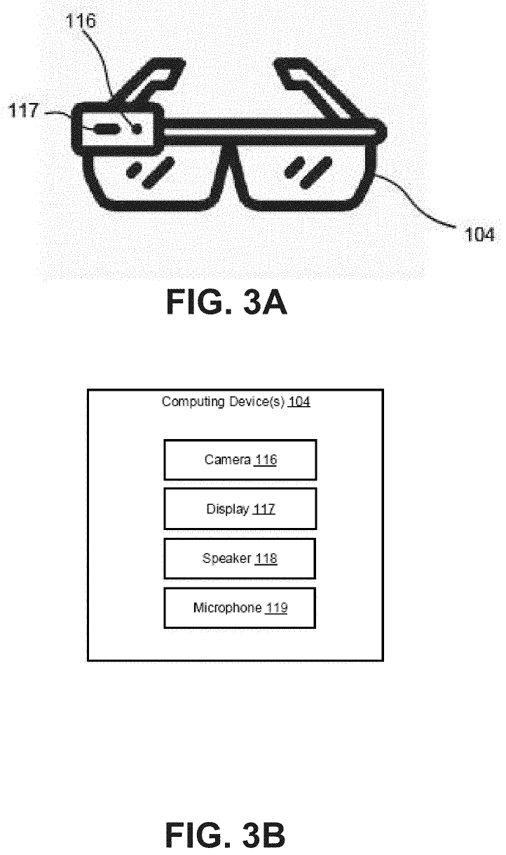

In some embodiments, client computing device 104 such as smart glasses, illustrated in FIGS. 3A-3B, may include a camera 116, a display 117 (e.g., comprising an OHMD), a speaker 118, and a microphone 119, among other standard components.

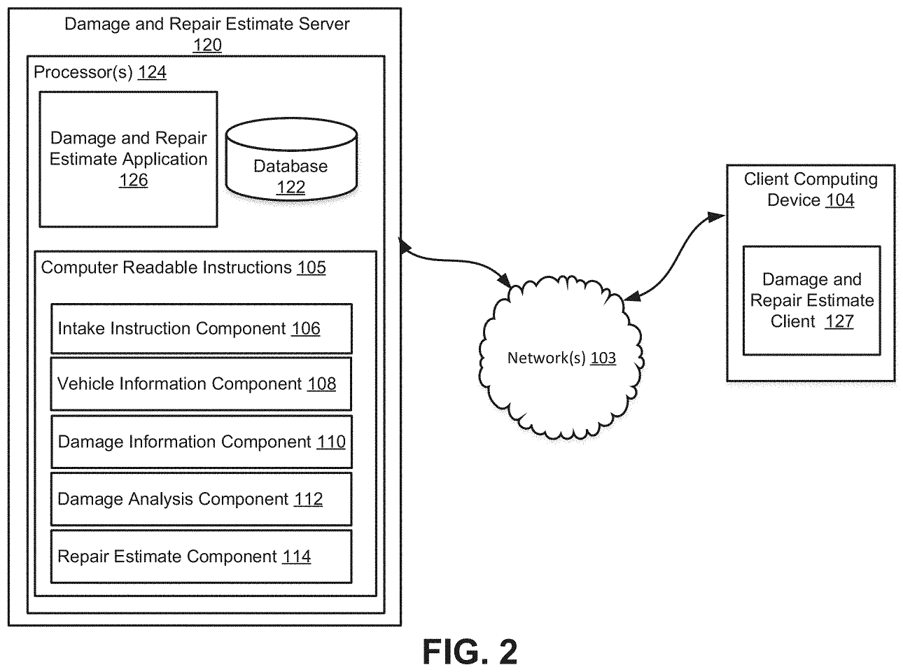

In some embodiments and as will be described in detail in FIG. 2, damage and repair estimate server 120 may include a processor, a memory, and network communication capabilities. In some embodiments, damage and repair estimate server 120 may be a hardware server. In some implementations, damage and repair estimate server 120 may be provided in a virtualized environment, e.g., damage and repair estimate server 120 may be a virtual machine that is executed on a hardware server that may include one or more other virtual machines. Additionally, in one or more embodiments of this technology, virtual machine(s) running on damage and repair estimate server 120 may be managed or supervised by a hypervisor. Damage and repair estimate server 120 may be communicatively coupled to a network 103.

In some embodiments, the memory of damage and repair estimate server 120 can store application(s) that can include executable instructions that, when executed by damage and repair estimate server 120, cause damage and repair estimate server 120 to perform actions or other operations as described and illustrated below with reference to FIG. 2. For example, damage and repair estimate server 120 may include damage and repair estimate application 126. In some embodiments, damage and repair estimate application 126 may be a distributed application implemented on one or more client computing devices 104 as client damage and repair estimate viewer 127. In some embodiments, distributed damage and repair estimate application 126 may be implemented using a combination of hardware and software. In some embodiments, damage and repair estimate application 126 may be a server application, a server module of a client-server application, or a distributed application (e.g., with a corresponding damage and repair estimate viewer 127 running on one or more client computing devices 104).

For example, user 160 may view and/or listen to the intake instructions that are displayed in a graphical user interface (GUI) of client damage and repair estimate viewer 127 on a display of wearable device 104 an/or transmitted via speaker 118, respectively, while performing the intake process in a handsfree manner. Additionally, client computing device 104 may accept user input via microphone 119 which allows user 160 to navigate through the intake instructions by using voice commands or gesture control, again leaving the user's hands free.

As alluded to above, distributed applications (e.g., damage and repair estimate application 126) and client applications (e.g., damage and repair estimate viewer 127) of damage and repair estimate server 120 may have access to microphone data included in client computing device 104. As alluded to above, users will access, view, and listen to intake instructions when performing data intake via client computing device 104 using voice commands or gesture control. In some embodiments, the commands entered by user 160 via microphone 119 of client computing device 104 (illustrated in FIG. 3B) may be recognized by damage and repair estimate application 126. For example, a command entered by user 160 may include user 160 speaking “View Damage Intake Instructions” command into microphone 119. In some embodiments, damage and repair estimate application 126 may have access to audio data collected by microphone 119 of client computing device 104. That is, damage and repair estimate application 126 may receive voice commands as input and trigger display events as output based on the voice commands of user 160, as described in further detail below. In yet other embodiments, damage and repair estimate application 126 may receive voice commands as input and trigger voice response events as output based on the voice commands of user 160, as further described in detail below.

The application(s) can be implemented as modules, engines, or components of other application(s). Further, the application(s) can be implemented as operating system extensions, module, plugins, or the like.

Even further, the application(s) may be operative locally on the device or in a cloud-based computing environment. The application(s) can be executed within or as virtual machine(s) or virtual server(s) that may be managed in a cloud-based computing environment. Also, the application(s), and even the repair management computing device itself, may be located in virtual server(s) running in a cloud-based computing environment rather than being tied to one or more specific physical network computing devices. Also, the application(s) may be running in one or more virtual machines (VMs) executing on the repair management computing device.

In some embodiments, damage and repair estimate server 120 can be a standalone device or integrated with one or more other devices or apparatuses, such as one or more of the storage devices, for example. For example, damage and repair estimate server 120 may include or be hosted by one of the storage devices, and other arrangements are also possible.

In some embodiments, damage and repair estimate server 120 may transmit and receive information to and from one or more of client computing devices 104, one or more vehicle information servers 130, one or more repair information servers 140, one or more intake instruction servers 150, and/or other servers via network 103. For example, a communication interface of the damage and repair estimate server 120 may be configured to operatively couple and communicate between client computing device 104 (e.g., a computer wearable device), vehicle information server 130, repair information server 140, and intake instruction server 150, which are all coupled together by the communication network(s) 103.

In some embodiments, vehicle information server 130 may be configured to store and manage vehicle information associated with a damaged vehicle. For example, vehicle information may include vehicle identification information, such as VIN number, make, model, and optional modifications (e.g., sub-model and trim level), date and place of manufacture, and similar information related to a damaged vehicle. The vehicle information server 130 may include any type of computing device that can be used to interface with the damage and repair estimate server 120. For example, vehicle information server 130 may include a processor, a memory, and a communication interface, which are coupled together by a bus or other communication link, although other numbers and/or types of network devices could be used. In some embodiments, vehicle information server 130 may also include a database 132. For example, database 132 may include a plurality databases configured to store content data associated with vehicle information, as indicated above. The vehicle information server 130 may run interface applications, such as standard web browsers or standalone client applications, which may provide an interface to communicate with the repair management computing device via the communication network(s). In some embodiments, vehicle information server 130 may further include a display device, such as a display screen or touchscreen, and/or an input device, such as a keyboard, for example.

In some embodiments, repair information server 140 may be configured to store and manage data related to an insurance carrier or other similar entity with respect to a damage incident (e.g., a collision accident). For example, the data related to an insurance carrier may include a claim number which was assigned by the insurance carrier upon submitting an insurance claim reporting a damage incident, information related to the insurance carrier, the owner of the damaged vehicle, the vehicle, the damage reported during claim submission for adjustment, policy information, deductible amount, and other similar data. In some embodiments, repair information server 140 may include any type of computing device that can be used to interface with the damage and repair estimate server 120 to efficiently optimize handsfree guided intake of information related to a damaged vehicle for the purpose of generating a repair estimate. For example, repair information server 140 may include a processor, a memory, and a communication interface, which are coupled together by a bus or other communication link, although other numbers and/or types of network devices could be used. In some embodiments, repair information server 140 may also include a database 142. For example, database 142 may include a plurality of databases configured to store content data associated with insurance carrier policy and claim, as indicated above. In some embodiments, repair information server 140 may run interface applications, such as standard web browsers or standalone client applications, which may provide an interface to communicate with the damage and repair estimate server 120 via the communication network(s) 103. In some embodiments, repair information server 140 may further include a display device, such as a display screen or touchscreen, and/or an input device, such as a keyboard, for example.

In some embodiments, intake instruction server 150 may be configured to store and manage information associated with intake instructions. Intake instruction server 150 may include processor(s), a memory, and a communication interface, which are coupled together by a bus or other communication link, although other numbers and/or types of network devices could be used. In some embodiments, intake instruction server 150 may also include a database 152. For example, database 152 may include a plurality of databases configured to store content data associated with intake instructions (e.g., workflow intake instructions, including textual information, images, videos, with and without an audio guide, and/or animations, including 3D animations) demonstrating how to perform intake of various information fora variety of different types and models of vehicles with different types of damage, which are insured by different insurance carriers in different geographical locations that may have different image requirements.

In some embodiments, vehicle information server 130, repair information servers 140, and intake instruction servers 150 may be a single device. Alternatively, in some embodiments, vehicle information server 130, repair information servers 140, and intake instruction servers 150 may include a plurality of devices. For example, the plurality of devices associated with vehicle information server 130, repair information servers 140, and intake instruction servers 150 may be distributed across one or more distinct network computing devices that together comprise one or more vehicle information server 130, repair information servers 140, and intake instruction servers 150.

In some embodiments, vehicle information server 130, repair information server 140, and intake instruction server 150, may not be limited to a particular configuration. Thus, in some embodiments, vehicle information server 130, repair information server 140, and intake instruction server 150 may contain a plurality of network devices that operate using a master/slave approach, whereby one of the network devices operate to manage and/or otherwise coordinate operations of the other network devices. Additionally, in some embodiments, vehicle information server 130, repair information server 140, and intake instruction server 150 may comprise different types of data at different locations.

In some embodiments, vehicle information server 130, repair information server 140, and intake instruction server 150 may operate as a plurality of network devices within a cluster architecture, a peer-to-peer architecture, virtual machines, or within a cloud architecture, for example. Thus, the technology disclosed herein is not to be construed as being limited to a single environment and other configurations and architectures are also envisaged.

Although the exemplary network environment 100 with computing device 104, damage and repair estimate server 120, vehicle information server 130, repair information server 140, intake instruction server 150, and network(s) 103 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as client computing device 104, damage and repair estimate server 120, vehicle information server 130, repair information server 140, and/or intake instruction server 150 may be configured to operate as virtual instances on the same physical machine. In other words, one or more of computing device 104, damage and repair estimate server 120, repair information server 140, and/or intake instruction server 150, may operate on the same physical device rather than as separate devices communicating through communication network(s). Additionally, there may be more or fewer devices than computing device 104, damage and repair estimate server 120, vehicle information server 130, repair information server 140, and/or intake instruction server 150.

In addition, two or more computing systems or devices can be substituted for any one of the systems or devices, in any example set forth herein. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including, by way of example, wireless networks, cellular networks, PDNs, the Internet, intranets, and combinations thereof.

In some embodiments, the various below-described components of FIG. 2, including methods, and non-transitory computer readable media may be used to automate the preparation of a repair estimate for a damaged vehicle

FIG. 2 illustrates an example damage and repair estimate server 120 configured in accordance with one embodiment. In some embodiments, as alluded to above, damage and repair estimate server 120 may include a distributed damage and repair estimate application 126 configured to guide the user during the intake of information process and analyze the intake input (e.g., captured damage images) in order to prepare a repair estimate. Additionally, intake instructions for capturing information related to the damage sustained by the vehicle in order to ensure compliance with specific carrier instructions may be generated. The intake instructions may be displayed on a display associated with client computing device 104, as further described in detail below. In some embodiments, user 160 may view the intake instructions, the captured intake information, and any information determined by damage and repair estimate server 120 via a GUI associated with damage and repair estimate viewer 127 running on client computing device 104.

In some embodiments, damage and repair estimate server 120 may also include one or more database(s) 122. For example, database 122 may include a database configured to store data associated with repair estimate generated by damage and repair estimate server 120 which are determined based on the damage information received from user 160. Additionally, database 122 may store damage information captured by user 160, as further described in detail below. Additionally, one or more databases of damage and repair estimate server 120 may include data related to user's 160 current and past interactions or operations with damage and repair estimate server 120, such as voice commands, gesture commands, and other input collected during the intake process. In yet other embodiments, database 122 may store machine learning data, and/or other information used by damage and repair estimate server 120.

In some embodiments, distributed damage and repair estimate application 126 may be operable by one or more processor(s) 124 configured to execute one or more computer readable instructions 105 comprising one or more computer program components. In some embodiments, the computer program components may include one or more of an intake instruction component 106, a vehicle information component 108, a damage information component 110, a damage analysis component 112, a repair estimate component 114, and/or other such components.

In some embodiments, intake instruction component 106 may be configured to generate handsfree directional intake instructions for guiding user 160 during the vehicle information and damage information intake process. The intake instructions may include instructions for capturing vehicle information and information related to the damage sustained by the vehicle. In some embodiments, the directional instructions may be shown on a display of computer wearable device 104.

In some embodiments, intake instruction component 106 may be configured to provide programmed instructions that instruct user 160 (e.g., a person performing a repair estimate) that is wearing client computing device 104 to capture vehicle identification information, such as a vehicle identification number (VIN). Next, intake instruction component 106 may be configured to provide programmed instructions that instruct user 160 to capture damage information related to the damaged vehicle (e.g., images of damaged panels or parts), as will be described further below. In some embodiments, intake instruction component 106 may be configured to provide programmed instructions that instruct user 160 to capture additional vehicle information (e.g., odometer reading, etc.).

For example, user 160 may capture an image associated with a VIN and/or license plate of the damaged vehicle and images of damaged panels of the vehicle. In other embodiments, user may provide vehicle identification information, such as audio data captured by a microphone (e.g., microphone 119, illustrated in FIG. 3B) of client computing device 104.

In some embodiments, user 160 may identify which information is being captured (e.g., vehicle identifying information or damage information). In some embodiments, the intake instructions for capturing vehicle and damage information may include text and/or directional arrows showing where to locate particular information.

For example, intake instruction component 106 may be configured to effectuate presentation of intake instructions via a GUI associated with damage and repair estimate viewer 127 running on client computing device 104 operated by user 160.

For example, intake instruction component 106 may effectuate presentation of one or more screens that user 160 may navigate using voice commands or gesture control, as set forth above. In some embodiments, each screen may be identified via a corresponding label. For example, a screen associated with intake of vehicle information may be identified as “Vehicle Information” or a similar descriptive label. Similarly, the screen associated with intake of owner information may be identified as “Damage Information”, and so on. In some embodiments, vehicle information determined by vehicle component 108 (e.g., VIN) may be displayed in subsequent information intake screens.

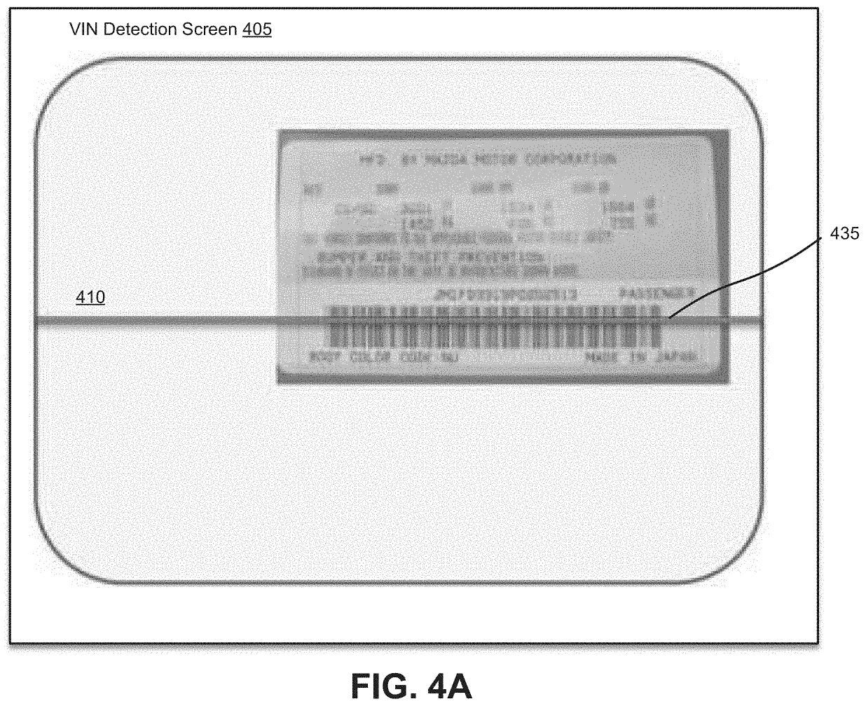

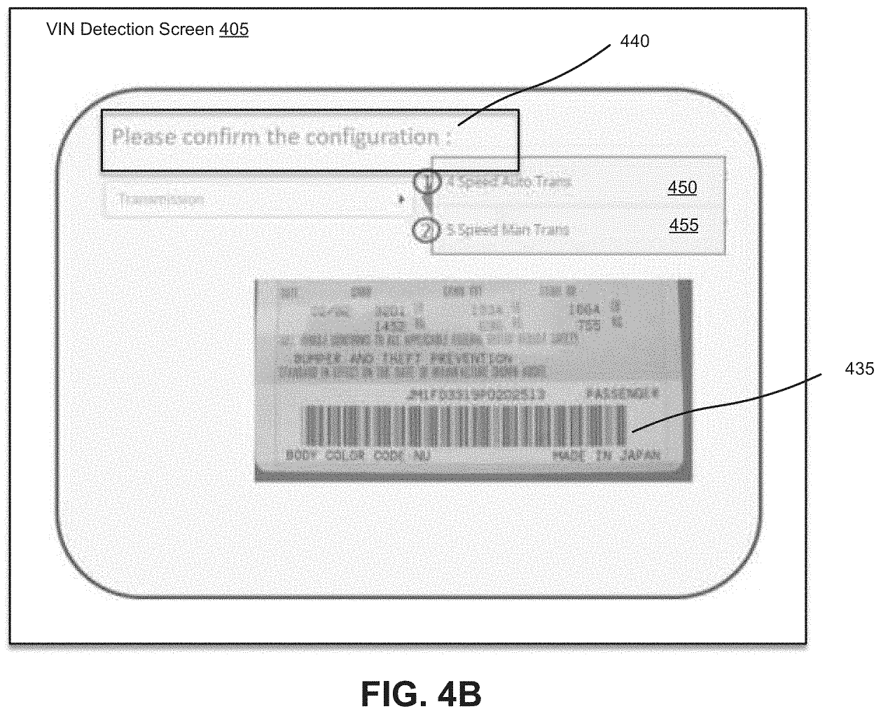

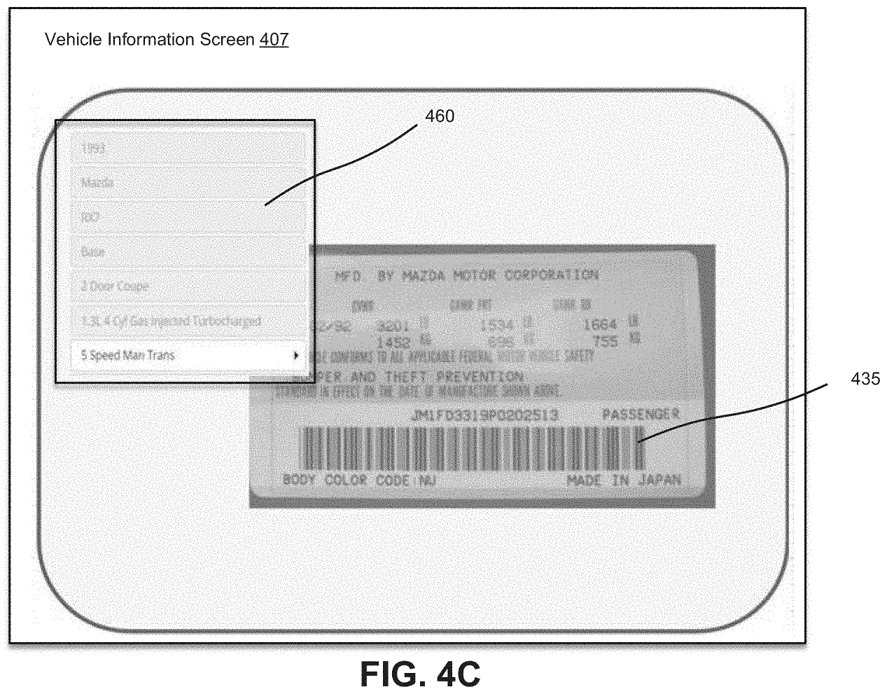

For example, when capturing vehicle information, user 160 may be presented with instructions for capturing the information associated with the damaged vehicle, as illustrated in FIGS. 4A-4C. For example, as illustrated in FIG. 4A, user 160 may be presented with VIN detection screen 405 within a display (e.g., OHMD) of computer wearable device 104 when capturing vehicle information of damaged vehicle. VIN detection screen 405 may include instructions (not illustrated) that instruct user 160 to center the image capture device of client computing device 104 on a VIN 430. In some embodiments, instructions may include a field of view window 410 within VIN detection screen 405 that force user 160 to focus on a VIN barcode 435.

In some embodiments, directional instructions may include one or more voice commands transmitted to speaker 118 of client computing device 104 (illustrated in FIG. 3B) informing user 160 what and/or when to capture the image associated of the vehicle or damage information. Different types of directional instructions may include voice commands, visual prompts, such as written text and arrows, or some combination of the above.

For example, as illustrated in FIG. 4B, upon scanning VIN barcode 435, directional instructions 440 may be presented to user 160. Directional instructions 440 may request a confirmation on whether a particular vehicle configuration identified by vehicle information component 108, as described further below) is correct. For example, user 160 may input that damaged vehicle's transmission is either automatic or manual. User 160 may confirm transmission 455 by either speaking the corresponding transmission types 450, 455 or by speaking the menu number associated with each transmission type (e.g., 4 or 5).

In some embodiments, intake instruction component 106 may generate directional instructions based on the positional information of user 160. For example, user 160 may obtain information associated with user's 160 location with respect to the vehicle. Next, intake instruction component 106 may determine that user 160 is not proximately positioned to the location or area corresponding to a part of the vehicle that displays the VIN number (e.g., windshield), or a panel with previously identified damage and generate an audio command instructing the user 160 to move to the correct location. That is, upon determining that user 160 is not in the location or area corresponding to the correct part of the vehicle (e.g., one that displays the VIN number or has a damaged part), the instructions may assist the user in located the correct area. In some embodiments, when determining user's 160 location with respect to the vehicle, intake instruction component 106 may use one or more of computer vision, device tracking, augmented reality, or similar technologies to identify user's 160 location.

In some embodiments, intake instruction component 106 may be configured to determine one or more display parameters for displaying intake instructions in a GUI associated with damage and repair estimate viewer 127 running on client computing device 104. For example, intake instruction component 106 may adjust the display of intake instructions based on the type of the display associated with client computing device 104 (e.g., OHMD).

In some embodiments, intake instruction component 106 may obtain device information from client computing device 104 related to its type, size of display, functional specifications, and other such information. Further, intake instruction component 106 may use the device information to obtain one or more display rules associated with that device. In some embodiments, intake instruction component 106 may determine a set of display instructions for displaying intake instructions in a format for optimized display on client computing device 104 based on the one or more display rules associated with client computing device 104.

In some embodiments, intake instruction component 106 may be configured to generate a handsfree confirmation informing user 160 that the image capture process of vehicle information and damage information was accomplished successfully. In some embodiments, the confirmation may include a message shown on the display of computer wearable device 104. In yet other embodiments, confirmation may include one or more voice commands transmitted to speaker 118 of client computing device 104 (illustrated in FIG. 3B) informing user 160 that the image capture process was accomplished successfully.

In some embodiments, vehicle information component 108 may be configured to collect and analyze vehicle information (e.g., vehicle identification information) that user 160 captured when being guided by intake instruction component 106. For example, vehicle information component 108 may analyze captured image data (e.g., VIN or the license plate number) to identify the damaged vehicle.

With respect to the captured image data related to the damaged vehicle, vehicle information component 108 may process the captured image data to extract the VIN or license plate number from the captured image data. For example, vehicle information component 108 may utilize stored optical character recognition programmed instructions to extract the VIN or license plate from the captured image data. In some embodiments, vehicle information component 108 may obtain vehicle information related to the damaged vehicle based on the extracted captured image data. For example, vehicle information component 108 may query database 132 of vehicle information server 130 (illustrated in FIG. 1) to obtain the make, model, and year of manufacturing of the vehicle by using the extracted VIN.

In some embodiments, vehicle identification component 108 may present all information related to the damaged vehicle upon user 160 capturing relevant data, as described herein. For example, as illustrated in FIG. 4C, upon scanning VIN barcode 435 (illustrated in FIG. 4A) and inputting additional information (illustrated in FIG. 4B), vehicle information screen 407 may present vehicle information 460 to user 160. Vehicle information 460 may include year of manufacture (e.g., 1993), make (e.g., Mazda), model (e.g., R×7), configuration (e.g., base), style (e.g., 2 door coupe), engine type (e.g., a 1.3 L. 4 cylinder, gas injected turbocharged engine), and transmission type (e.g., 5 speed manual transmission).

In some embodiments, intake instruction component 106 may be configured to generate handsfree directional intake instructions for guiding user 160 during the intake of the information related to the damage sustained by the vehicle.

Similar to vehicle information intake, as described above, intake instruction component 106 may be configured to effectuate presentation of damage intake instructions via a GUI associated with damage and repair estimate viewer 127 running on client computing device 104 operated by user 160.

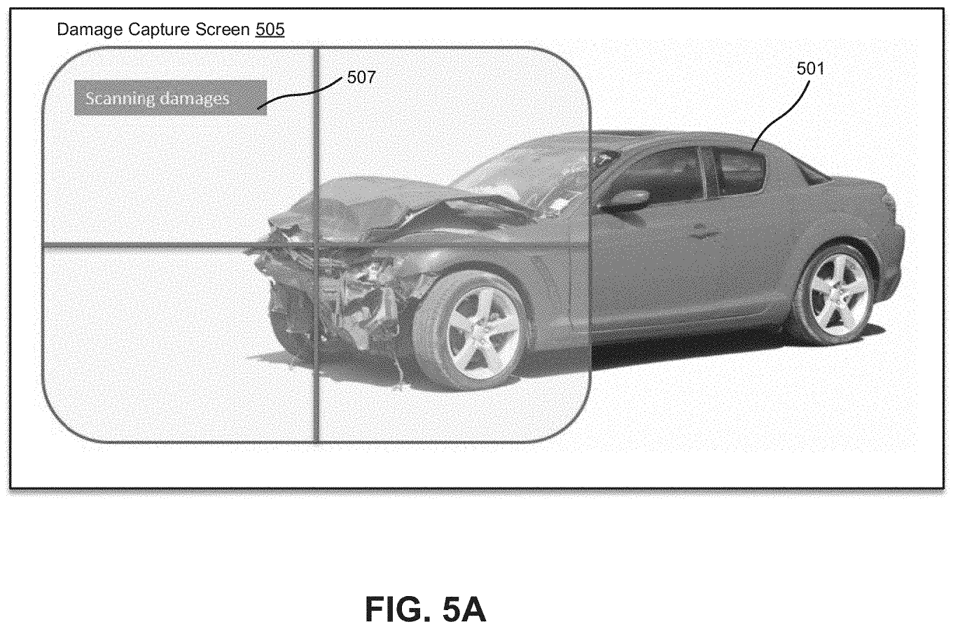

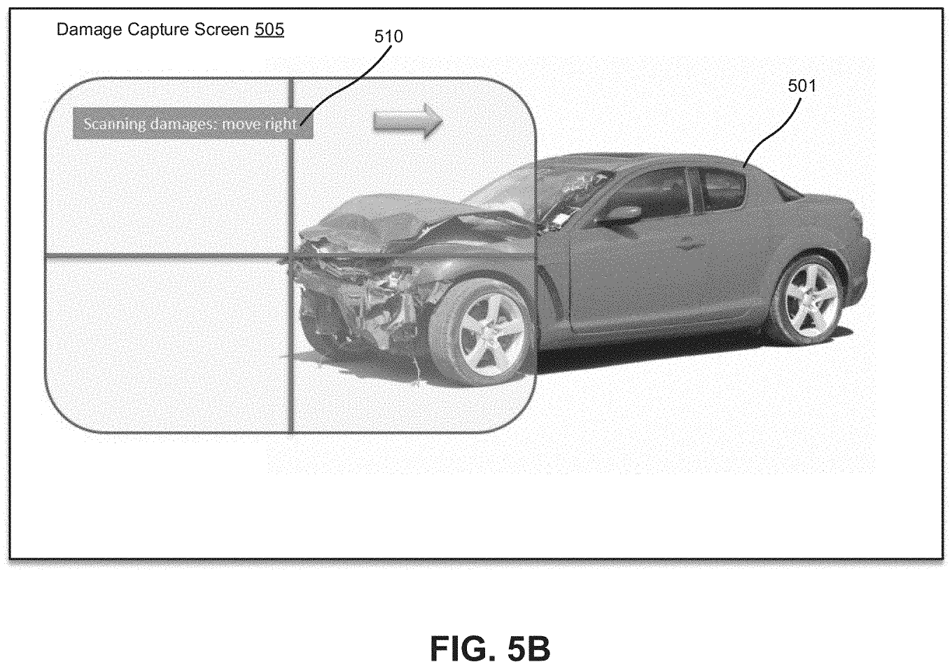

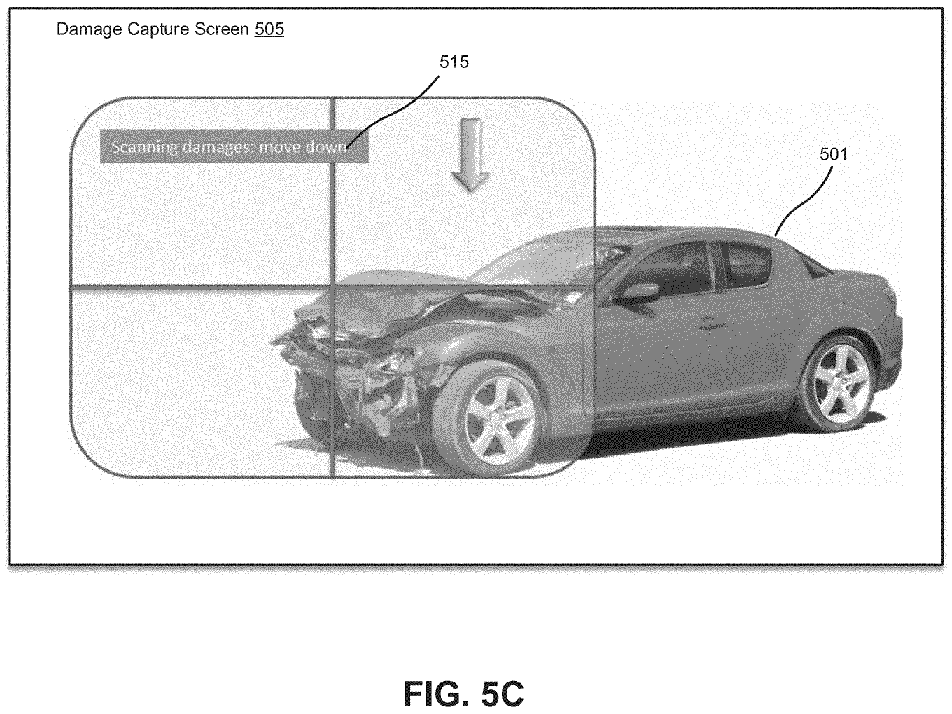

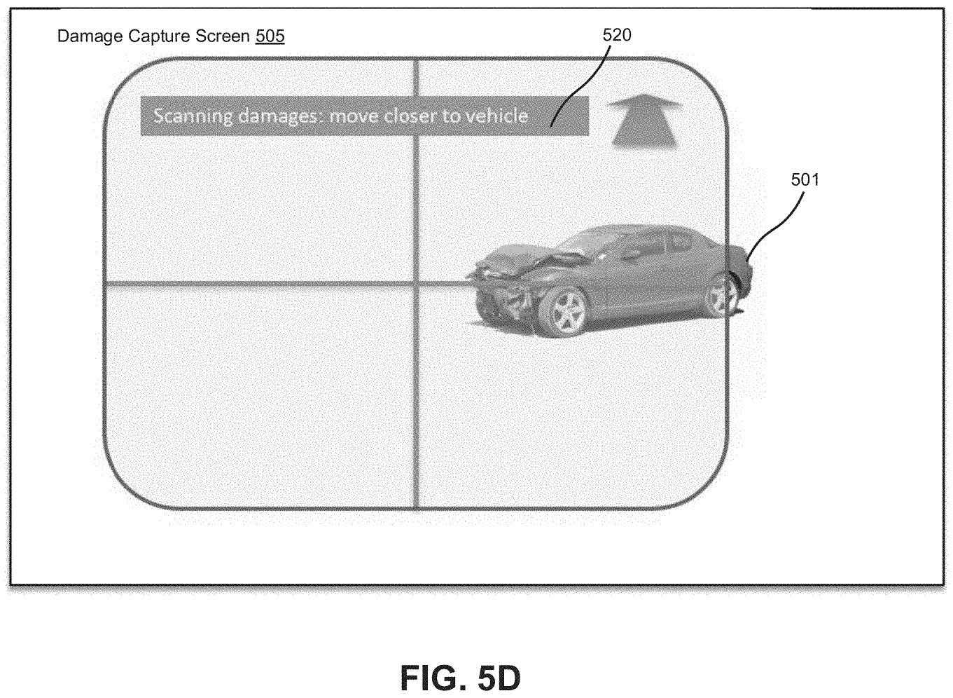

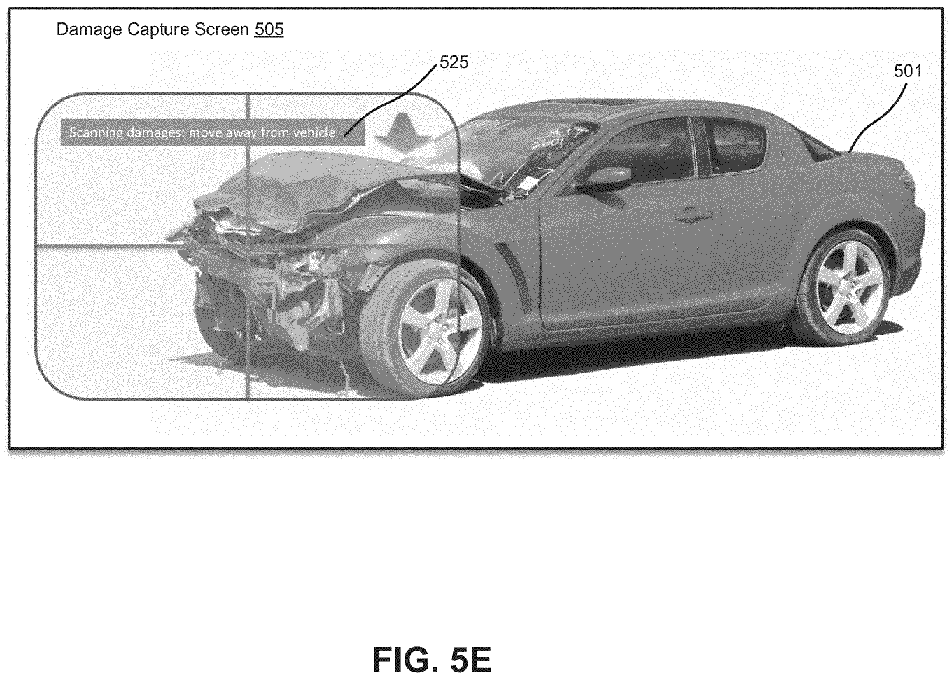

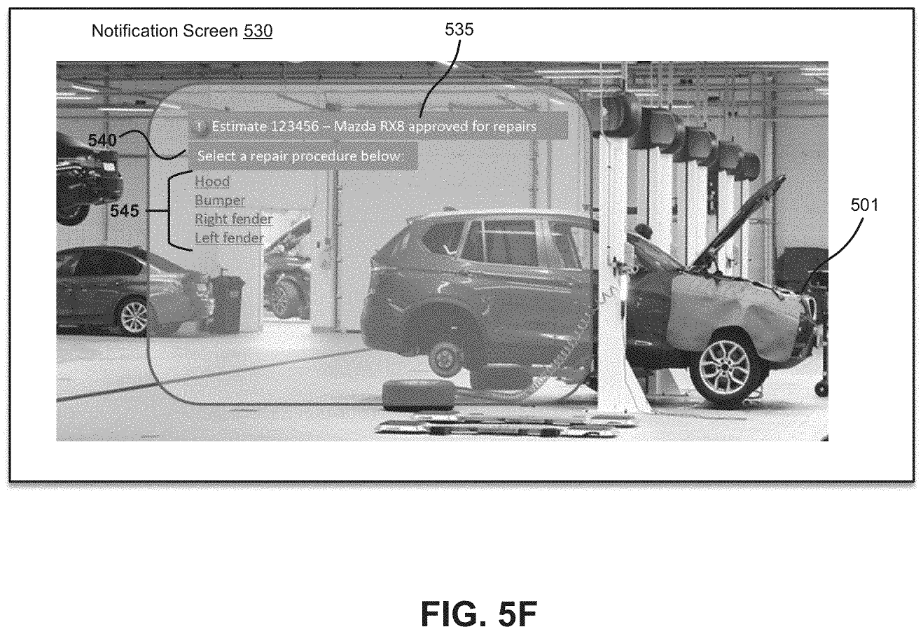

In some embodiments, intake instruction component 106 may query database 152 of intake instruction server 150 (illustrated in FIG. 1) to obtain damage intake instructions by using vehicle information obtained by vehicle information component 108 (e.g., the extracted VIN). For example, when capturing damage information, user 160 may be presented with instructions for capturing the information associated with the damaged vehicle, as illustrated in FIGS. 5A-5E. For example, as illustrated in FIG. 5A-5D, user 160 may be presented with damage capture screen 505 within a display (e.g., OHMD) of computer wearable device 104 when capturing damage related data. Damage capture screen 505 may include instructions that instruct user 160 to move the image capture device of client computing device 104 to optimize the image capture. For example, in FIG. 5A, instructions 507 may inform user 160 to “Scan the damages.” That is, user 160 is directed to obtain a complete image of a vehicle 503.

In some embodiments, damage information component 110 may be configured to collect damage information that user 160 captured when being guided by intake instruction component 106. For example, damage information component 110 may collect captured images of various panels and parts of the damaged vehicle during the damage scan, as illustrated in FIG. 5A. In some embodiments, damage information component 110 may collect image data as user 160 is walking around the vehicle. The image data is captured using one or more image capture techniques, such as panoramic image scanning, 3D image scanning, and similar such techniques.

In some embodiments, damage information component 110 may use the captured images to determine particular panels that have sustained damage. For example, damage information component 110 may be configured to identify individual panels based on their appearance of the objects conveyed by the output signals of the one or more image sensors of the image capture devices.

In some embodiments, damage information component 110 may be configured to identify the panels based on their appearance using one or more computer vision techniques, image classification techniques, machine-learning techniques, and/or other techniques. For example, damage information component 110 may be configured to obtain information conveying the appearance of the panels, and classify the image using one or more image classification techniques to identify the panel. The appearance of the panels may be determined by obtaining output signals of the one or more sensors of image capture device associated with client computing device 104 (e.g., image sensor and/or other sensors).

In some embodiments, damage information component 110 may be configured to identify the panels by using proximity and location information, and/or other information. For example, the panels may be identified by determining their location with respect to the vehicle (i.e., proximity to other panels vehicle).

In some embodiments, damage information component 110 may be configured to identify which panels have sustained damage. For example, damage information component 110 may use one or more computer vision techniques, image classification techniques, machine-learning techniques, and/or other techniques to identify a damaged panel based on its appearance. In some embodiments, damage information component 110 may be configured to compare visual information obtained during the image capturing process and compare it to a template or “model” image of the same panel to identify damage.

In some embodiments, damage information component 110 may be configured to determine damage information associated with the damaged panel. For example, damage information component 110 may use one or more computer vision techniques, image classification techniques, machine-learning techniques, and/or other techniques to determine the extent and/or severity of panel deformation. For example, by analyzing some of the damage images, damage information component 110 may determine that the front hood and front bumper have been damaged in a collision. Accordingly, intake instruction component 106 may generate additional damage intake instructions based on the determination by damage information component 110. In FIG. 5B, instructions 507 may inform user 160 to move the image capture device to the right so as to capture the damage to the front hood and front bumper of vehicle 501 more closely.

Likewise, in FIG. 5C, instructions 515 may inform user 160 to move the image capture device down. In FIG. 5D, instructions 520 may inform user 160 to move the image capture device closer to vehicle 501. In FIG. 5E, instructions 525 may inform user 160 to move the image capture device away from vehicle 501.

In some embodiments, intake instruction component 106 may determine damage intake instructions associated with particular automobile insurance carriers. For example, intake instruction component 106 may obtain automobile insurance policy claim information associated with the vehicle by using the vehicle information obtained by vehicle information component 108. For example, damage information component 110 may query database 142 of repair information server 140 (illustrated in FIG. 1) to obtain an insurance claim information (e.g., claim number) associated with the damaged vehicle having a particular VIN.

The insurance policy claim information associated with the vehicle may include information related to the damage the vehicle sustained during the incident, as reported during claim submission. The damage information included in the insurance policy claim may be used to determine damage intake instructions for capturing the images or videos of the damage, as described further below. For example, the damage information may include wide shots of the damaged vehicle, pictures of an identification number associated with the damaged vehicle (e.g., a vehicle identification number (VIN), etc.), current odometer reading, and/or multiple angles/close-up shots of the damage associated with the insured vehicle. In some embodiments, intake instructions may require that user 160 captures image data related to at least two different angles of the damage for each panel (e.g., hood, fender, door, bumper, etc.) based on the claim description of the damage.

In some embodiments, an insurance carrier may require capturing images from each of the “four corners” of a damaged vehicle. By capturing images from each of the corners allows to create a general view of the vehicle. Additionally, because this type of image capturing results in a perspective view of all the panels, individual panels (such as doors and fenders) are viewed with respect to other panels. Viewing the panels in perspective results in capturing additional information than it otherwise would if the image is made in isolation (e.g., right in front of a damaged panel). For example, perspective view may capture neighboring panels that may also be deformed.

In some embodiments, damage information component 110 may be configured to analyze images captured from the “four corners” of the vehicle. As a result, damage information component 110 may identify all the panels that have sustained damage. That is, damage information component 110 may be configured to determine all the damaged panels by analyzing the visual data of the captured images. Alternatively, damage information component 110 may be configured to determine that additional damaged panels may be damaged by analyzing proximal damaged panels. For example, upon determining that a frontal grill is damaged, damage information component 110 may determine that the likelihood of a radiator, which is located behind the grill, is high.

In some embodiments, intake instruction component 106 may direct user 160 to capture additional images of all panels identified by damage information component 110 as damaged or likely to be damaged, as explained above. Conversely, damage information component 110 may identify all the panels that have not sustained damage. In that scenario, intake instruction component 106 may not be directing user 160 to capture those panels, as that information is not relevant.

In some embodiments, the intake instructions for capturing damage data may be dependent on the geographic location (e.g., country or state) where the incident occurred, the insurance carrier, including its geographic location, or the type of policy that the owner has with the carrier. For example, different insurance carriers may have different requirements for the number and types of images when preparing a repair estimate. Thus, one insurance carrier may require only one image (i.e., front view) depicting the damage, while other carriers may require multiple images of different views (i.e., front and side views) that depict the damage.

By using the damage information obtained by damage information component 110, insures that user 160 automatically receives all relevant instructions for capturing intake information in a handsfree manner (i.e., without consulting additional documents) resulting in an efficient intake process.

In some embodiments, damage information component 110 may be configured to collect damage information that user 160 captured when being guided by intake instruction component 106. For example, damage information component 110 may collect captured image data associated with various panels and parts of the damaged vehicle.

In some embodiments, damage information component 110 may use the captured image of damage information to determine whether additional damage images may need to be captured. For example, by analyzing some of the damage images, damage information component 110, may determine that panels that were not directly harmed in a collision accident, for example, may have sustained indirect damage and thus may need to be replaced. Accordingly, intake instruction component 106 may generate additional damage intake instructions based on the determination by damage information component 110.

Additionally, the intake instructions may be dependent on the type of damage, its severity, and/or other factors related to the damage. For example, capturing vehicle damage associated with a frontal grill may include instructions for capturing images depicting side fenders in addition to the frontal grill. Accordingly, intake instruction component 106 may be configured to generate intake instructions for gathering damage data based on the analysis of damage data by damage information component 110.

As set forth above, a damaged vehicle may have more than one area that has been damaged during an incident. For example, in a collision accident, a vehicle may have damage to a front bumper, a windshield, and a front passenger door. Accordingly, intake instruction component 106 may obtain intake instructions based on a particular vehicle panel indicated by visual input, e.g., image data captured by user 160 wearing client computing device 104. For example, a front fender of a damaged vehicle may be included in the visual input provided by client computing device 104. Upon processing the captured image data and identifying one or more vehicle panels that have been damaged, intake instruction component 106 may automatically obtain intake instructions for capturing the damage to those vehicle panels.

In some embodiments, damage analysis component 112 may analyze damage information (e.g., images of damaged vehicle panels) captured by intake instruction component 106 and identify one or more damaged vehicle panels. In some embodiments, damage analysis component 112 may identify one or more parts comprising each of the damaged panels. Further, damage analysis component 112 may obtain repair information associated with replacing and/or repairing a particular part of each panel (e.g., cost of part, cost of paint, labor rates, and other similar information related to repairing to the damage). For example, damage analysis component 112 may query database 142 of repair information server 140 (illustrated in FIG. 1) to obtain repair information associated with a particular panel of a damaged vehicle having a particular VIN. By virtue of identifying damaged panels and parts, the system eliminates manual data entry conventionally performed by a repair estimator when obtaining estimate information.

In some embodiments, damage analysis component 112 may analyze repair information, as described above, associated with the damaged vehicle panels captured by intake instruction component 106, and any additional information (e.g., insurance carrier requirements) in conjunction with one or more predictive models to determine a repair estimate for repairing the damage. The predictive models may include one or more of neural networks, Bayesian networks (e.g., Hidden Markov models), expert systems, decision trees, collections of decision trees, support vector machines, or other systems known in the art for addressing problems with large numbers of variables. Specific information analyzed during the determination of the repair estimate may vary depending on the desired functionality of the particular predictive model.

As set forth above, damage analysis component 112 may be configured to use machine learning, i.e., a machine learning model that utilizes machine learning to determine a repair estimate. For example, in a training stage, damage analysis component 112 can be trained using training data (e.g., repair information, damage severity information, and/or other historical data related to similarly damaged vehicles or similarly damages on other vehicles) of actual repair estimates. Then, at an inference stage, damage analysis component 112 can determine a repair estimate for the damaged panel or other data it receives. In some embodiments, the machine learning model can be trained using synthetic data, e.g., data that is automatically generated by a computer, with no use of user information.

In some embodiments, damage analysis component 112 may be configured to use one or more of a deep learning model, a logistic regression model, a Long Short Term Memory (LSTM) network, supervised or unsupervised model, etc. In some embodiments, repair procedures identification component 108 may utilize a trained machine learning classification model. For example, the machine learning may include decision trees and forests, hidden Markov models, statistical models, cache language model, and/or other models. In some embodiments, the machine learning may be unsupervised, semi-supervised, and/or incorporate deep learning techniques.

In some embodiments, repair estimate component 114 may be configured to generate a repair estimate report based on the information captured by user 160, i.e., information obtained by intake instruction component 106, vehicle information component 108, damage information component 110, and/or damage analysis component 112.

In some embodiments, repair estimate component 114 may be configured to effectuate presentation of the report in a GUI associated with damage and repair estimate viewer 127 running on client computing device 104 so it can be accessed and viewed by user 160.

In some embodiments, repair estimate component 114 may transmit the report to another party or system. For example, the repair estimate report generated by repair estimate component 114 may be transmitted to an insurance carrier or another party. In some embodiments, repair estimate component 114 may identify vehicle owner information and/or a corresponding insurance claim when submitting the repair estimate to the insurance carrier for review and approval.

In some embodiments, repair estimate component 114 may be configured to receive a response from the insurance carrier, e.g., an approval or rejection of the transmitted repair estimate. For example, the response may be transmitted to user 160 by displaying a notification in a display of computing device 104. In some embodiments, as illustrated in FIG. 5F, user 160 may be presented with a notification screen 530 within a display (e.g., OHMD) of computer wearable device 104 when capturing damage related data. User 160 may receive a notification 535 informing the user that the estimate report for Mazda R×8 has been approved.

In some embodiments, the estimate report may be identified by a corresponding report number (e.g., 123456).

In some embodiments, upon receiving a rejection from the insurance carrier or a request for additional information. (for example, a request for additional images), repair estimate component 114 may generate a corresponding notification to user 160. By virtue of receiving a response from the insurance carrier, the repair technician has the ability to know when the repairs are approved without having to log into a desktop computer to check the status of the estimate. Furthermore, the repair technician may address any requests by the insurance carrier (e.g., requests for additional images) without unnecessary delay.

In some embodiments, upon receiving an approval from the insurance carrier, repair estimate component 114 may be configured to obtain individual repair steps and the order in which they must be performed, associated with the repair estimate report. For example, individual repair steps may be displayed in a computing device, e.g., in a GUI associated with repair procedure viewer 127 running on computer wearable device 104. As illustrated in FIG. 5F, repair steps 545 may be presented to user 160 in a notification screen 530.

By virtue of obtaining repair process information, including information related to how the repair procedure documents were viewed, as alluded to above, allows the system to furnish evidence that may be helpful in establishing future repair shop liability. That is, conventional repair shops can only demonstrate which repair procedure documents were printed but may not provide information which ones were actually viewed.

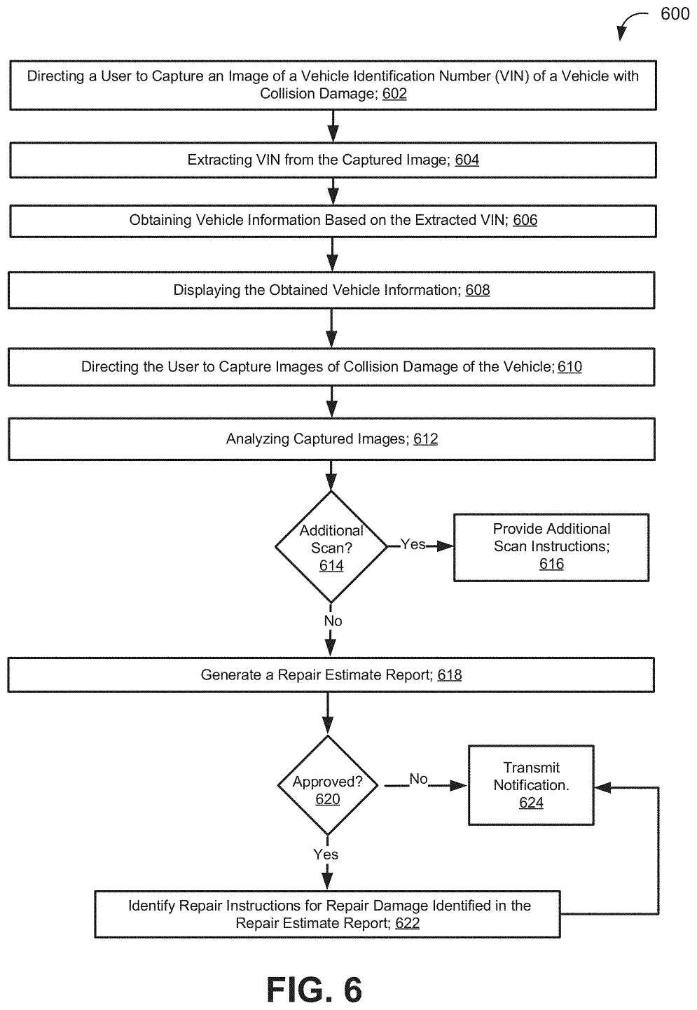

FIG. 6 illustrates a flow diagram depicting a method for automating assessment of captured damage image data and preparation of a repair estimate of collision damage to a vehicle when using a handsfree, voice guided intake of information, in accordance with one embodiment. In some embodiments, method 600 can be implemented, for example, on a server system, e.g., damage and repair estimate server 120, as illustrated in FIGS. 1-2.

At operation 602, a user of a computer wearable device is directed to capture an image used to identify a damaged vehicle (e.g., VIN) and an owner of the damaged vehicle (e.g., driver's license), for example by intake capture component 106. At operation 604, vehicle information is extracted from the captured image, for example by vehicle information component 108. Vehicle information component 108 may utilize optical character recognition to extract the VIN, although other techniques may be used, such as processing a scan of a bar code with the VIN by way of example.

At operation 606, vehicle information (e.g., make, model, and year of manufacture) associated with the damaged vehicle having the extracted VIN may be obtained.

At operation 608, all information related to the damaged vehicle obtained at operation 606 may be displayed in a within a display (e.g., OHMD) of computer wearable device 104, as illustrated in FIG. 4C, for example.

At operation 610, intake instructions for capturing damage information are generated based on the extracted VIN, as illustrated in FIGS. 5A-5E, for example. In some embodiments, additional instructions may be provided for capturing additional views, angles, and/or images based on analyzing previously captured images of the collision damage to the vehicle.

At operation 612, captured images of the collision damage are analyzed to identify one or more damaged panels and parts within each of the panels, determine the extent of the damage, and whether each of those parts may be repaired or replaced, for example by damage analysis component 112.

At operation 614, a determination whether any additional captured images of the collision damage to the vehicle are required is made. If, at operation 614, a determination that one or more additional captured images of the collision damage to the vehicle are required, then the “Yes” branch can be taken to operation 616. For example, at operation 614, a determination that one or more additional captured images, such as pictures or video, are required in order to analyze and assess the damage, causes a display of intake instructions for capturing additional damage information to be generated in real-time, at operation 616. Upon capturing additional images, the images are analyzed as described earlier in connection with operation 612.

If, at operation 614, a determination that one or more additional captured images of the collision damage to the vehicle are not required, then the “No” branch can be taken to operation 618.

At operation 618, an automated repair estimate for parts and labor to repair the collision damage is generated and submitted to a corresponding insurance carrier for review and approval. At operation 620, a determination whether approval of the submitted repair estimate is received from the corresponding insurance carrier.

If, at operation 620, the approval from the insurance carrier is received, then the “Yes” branch may be taken to operation 622. At operation 622, repair instructions for repairing the damage identified in the repair estimate may be obtained. In some embodiments, the repair instructions may be displayed in an optimized order to ensure that all the steps of the repair process are properly executed.

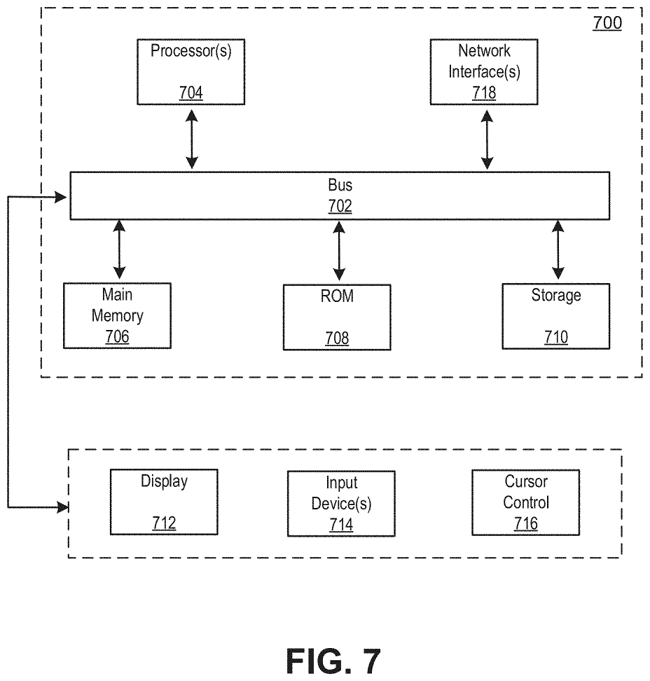

At operation 624, the repair estimate status may be provided to user 160. For example, approval or rejection of the generated repair estimate report may be transmitted.

Where circuits are implemented in whole or in part using software, in one embodiment, these software elements can be implemented to operate with a computing or processing system capable of carrying out the functionality described with respect thereto. One such example computing system is shown in FIG. 7. Various embodiments are described in terms of this example-computing system 700. After reading this description, it will become apparent to a person skilled in the relevant art how to implement the technology using other computing systems or architectures.

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a transparent heads-up display (HUD) or an optical head-mounted display (OHMD), for displaying information to a computer user. An input device 714, including a microphone, is coupled to bus 702 for communicating information and command selections to processor 704. An output device 716, including a speaker, is coupled to bus 702 for communicating instructions and messages to processor 704.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 705. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 705. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire, and fiber optics, including the wires that comprise bus 702. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining a first set of images of a vehicle damaged during an adverse incident, wherein the first set of damaged vehicle images is captured by a computing device operated by a user;
identifying individual parts of the damaged vehicle associated with the first set of damaged vehicle images;
determining damage information associated with each of the identified individual parts of the damage vehicle;
obtaining repair information for repairing individual damaged parts of the damaged vehicle based on the determined damage information; and
generating a repair estimate report based on the repair information associated with repairing individual damaged parts.

2. The method of claim 1, further comprising:
obtaining vehicle identification information by processing images of vehicle identification information, wherein the vehicle identification information is associated with the damaged vehicle;
extracting Vehicle Identification Number (VIN) from the captured image of the vehicle identification information; and
identifying the damaged vehicle based on the extracted VIN, wherein the identifying the damaged vehicle comprises identifying a make, a model, a sub-model, a trim level, and a year of manufacture of the damaged vehicle.

3. The method of claim 2, further comprising:
generating a first set of instructions that guide the user during the image capture process of the first set of damaged vehicle images;
wherein the first set of instructions is generated based on the vehicle identification information.

4. The method of claim 1, further comprising
obtaining a second set of damaged vehicle images based on the identified individual parts of the damaged vehicle, wherein the second set of damaged vehicle images is captured by the computing device operated by the user.

5. The method of claim 4, further comprising:
generating a second set of instructions that guide the user during the image capture process of the second set of damaged vehicle images;
wherein the second set of instructions is generated based on the damage information associated with each of the identified individual parts of the damage vehicle.

6. The method of claim 1, wherein identifying individual parts of the damaged vehicle associated with the first set of damaged vehicle images comprises using one or more image processing techniques.

7. The method of claim 1, wherein determining the damage information associated with each of the identified individual parts of the damage vehicle comprises using a machine learning algorithm trained on the historic repair estimate information.

8. The method of claim 1, wherein the computing device comprises a computer wearable device worn by the user configured to facilitate handsfree repair of the damaged vehicle.

9. The method of claim 2, further comprising identifying an insurance carrier associated with the adverse incident based on the vehicle identification information; and
transmitting the generated repair estimate report to the insurance carrier.

10. The method of claim 9, further comprising generating a notification upon obtaining an approval of the transmitted repair estimate report from the insurance carrier.

11. A system for automating a repair estimation intake process, the system comprising:
one or more physical processors configured by machine-readable instructions to:
obtain a first set of images of a vehicle damaged during an adverse incident, wherein the first set of damaged vehicle images is captured by a computing device operated by a user;
identify individual parts of the damaged vehicle associated with the first set of damaged vehicle images;
determine damage information associated with each of the identified individual parts of the damage vehicle;
obtain repair information for repairing individual damaged parts of the damaged vehicle based on the determined damage information; and
generate a repair estimate report based on the repair information associated with repairing individual damaged parts.

12. The system of claim 11, wherein the one or more physical processors are further configured to:
obtain vehicle identification information by processing images of vehicle identification information, wherein the vehicle identification information is associated with the damaged vehicle;
extract Vehicle Identification Number (VIN) from the captured image of the vehicle identification information; and
identify the damaged vehicle based on the extracted VIN, wherein the identifying the damaged vehicle comprises identifying a make, a model, a sub-model, a trim level, and a year of manufacture of the damaged vehicle.

13. The system of claim 12, wherein the one or more physical processors are further configured to:
generate a first set of instructions that guide the user during the image capture process of the first set of damaged vehicle images;
wherein the first set of instructions is generated based on the vehicle identification information.

14. The system of claim 11, wherein the one or more physical processors are further configured to:
obtain a second set of damaged vehicle images based on the identified individual parts of the damaged vehicle, wherein the second set of damaged vehicle images is captured by the computing device operated by the user.

15. The system of claim 14, wherein the one or more physical processors are further configured to:
generate a second set of instructions that guide the user during the image capture process of the second set of damaged vehicle images;
wherein the second set of instructions is generated based on the damage information associated with each of the identified individual parts of the damage vehicle.

16. The system of claim 11, wherein the individual parts of the damaged vehicle associated with the first set of damaged vehicle images are identified by using one or more image processing techniques.

17. The system of claim 11, wherein the damage information associated with each of the identified individual parts of the damage vehicle is determined by using a machine learning algorithm trained on the historic repair estimate information.

18. The system of claim 11, wherein the one or more physical processors are further configured to: identify an insurance carrier associated with the adverse incident based on the vehicle identification information; and
transmit the generated repair estimate report to the insurance carrier.

19. The system of claim 18, further comprising generating a notification upon obtaining an approval of the transmitted repair estimate report from the insurance carrier.

20. The system of claim 11, wherein the computing device comprises a computer wearable device worn by the user configured to facilitate handsfree repair of the damaged vehicle.

21. A non-transitory machine readable medium having stored thereon instructions comprising executable code which when executed by one or more processors, causes the processors to:
obtain a first set of images of a vehicle damaged during an adverse incident, wherein the first set of damaged vehicle images is captured by a computing device operated by a user;
identify individual parts of the damaged vehicle associated with the first set of damaged vehicle images;
determine damage information associated with each of the identified individual parts of the damage vehicle;
obtain repair information for repairing individual damaged parts of the damaged vehicle based on the determined damage information; and
generate a repair estimate report based on the repair information associated with repairing individual damaged parts.
